(19) United States
(12) Patent Application Publication
(10) Pub. No.: US 2005/0182535 A1
(43) Pub. Date: Aug. 18, 2005

(54) Device and method for identifying a specific communication protocol used in an on-board diagnostic tool

(76) Inventor: David Huang, Shanghai (CN)

Correspondence Address: Bruce B. Brunda;STETINA BRUNDA GARRED & BRUCKER, Suite 250, 75 Enterprise, Aliso Viejo, CA, 92656, US

(21) Appl. No.: 10/779,985

(22) Filed: Feb. 17, 2004

(51) Int. Cl. G06F 19/00

(52) U.S. Cl. 701/29; 340/438

(57) ABSTRACT

A method for identifying a specific communications protocol used in a vehicle's on-board diagnostic system, wherein the method is implemented using a handheld automotive diagnostic device and cable having a first and second connector, wherein the cable has unique physical layer features that may be correlated to a specific communications protocol. The method comprises connecting the first connector to an input/output connector on the diagnostic device; powering up and initializing the diagnostic device; retrieving cable identification data unique to the physical layer features of the cable; and comparing the retrieved cable identification data with at least one look-up table to identify a correlated communications protocol.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

1. Field of the Invention

The present invention relates to handheld automotive diagnostic tools and cables that are connected between a vehicle and the diagnostic tool. In particular, the present invention relates to a system for identifying a specific communication protocol used in a vehicle's on-board diagnostic system by retrieving unique data indicative of a unique cable.

2. Background of the Invention

One of the most exciting improvements in the automobile industry was the addition of on-board diagnostics (OBD) on vehicles. On-board diagnostic systems are now in most cars and light trucks on the road today. During the 1970's and early 1980's manufacturers started using electronic means to control engine functions and diagnose engine problems primarily to meet EPA emission standards.

On-board diagnostics were first voluntarily introduced in the early 1980's. There were few standards and each manufacturer had their own systems and signals. Next, the California Air Resources Board (CARB) required OBD-I which was designed to monitor manufacturer-specific systems on vehicles built from 1981 to 1995. Then in 1996, OBD-II was introduced, which is now mandatory on all 1996 and newer vehicles sold in the U.S.

Like its predecessor, OBD II was mandated by CARB and the EPA to lower vehicle emissions. OBD-II provides almost complete engine control and also monitors parts of the chassis, body and accessory devices, as well as the diagnostic control network of the car. But what makes OBD II unique is its universal application for all late model cars and trucks—domestic and import. This sophisticated program in the vehicle's main computer system is designed to detect failures in a range of systems, and can be accessed through a standardized J1962 connector which is usually found under the dash. A cable is plugged into the OBD-II J1962 connector and connected to a scan tool. The J1962 connector is a 16-pin unit. Of the sixteen pins provided on the connector, only seven are standardized per OBD-II specifications. All other pins are available for use by the manufacturer and vary from vehicle to vehicle.

While the parameters, or readings, required by OBD II regulations are uniform, the auto manufacturers do have some latitude in the communications protocol they used to transmit those readings to automotive diagnostic tools. There are various OBD-II protocols in use, each with minor variations on the communication pattern between the on-board diagnostic computer and the diagnostic tool. While there have been some manufacturer changes between protocols in the past few years, as a rule of thumb, Chrysler products and all European and most Asian imports use ISO 9141 circuitry. GM cars and light trucks use SAE J1850 VPW (Variable Pulse Width Modulation), and Fords use SAE J1850 PWM (Pulse Width Modulation). Moreover, additional further enhanced protocols are now being deployed including Keyword 2000, and the CAN protocol.

While the OBD-II system is now quickly becoming the prevalent on-board diagnostics system utilized in most vehicles, there are still many pre-1996 model vehicles which use OBD-I. One of the disadvantages with OBD-I, is that each manufacturer utilized different on-board computer systems, connectors, and communication protocols in their vehicles. In other words, OBD-I is far less standardized than OBD-II. For instance, between 1982 and 1995, General Motors utilized a 12-pin ALDL computer in their on-board diagnostics system. And, between 1983 and 1995, Ford installed EEC-IV computers with a different connector into there vehicles for the on-board diagnostics systems. Additionally, between 1983 and 1995, Chrysler utilized a SCI computer for their on-board diagnostics system and used yet another different connector. As a result, the OBD-I systems have less standardization than does the more modern OBD-II system.

Nevertheless, what is common to both OBD-I and OBD-II, is that specialized diagnostic equipment, such as a code readers, are required to be connected to the vehicle's on-board diagnostic connector to download Diagnostic Trouble Codes (DTC) which identify where the problem occurred. In most instances, the more sophisticated diagnostic consoles costing thousands of dollars include the decoding software and firmware capable of supporting both OBD-I and OBD-II. Furthermore, the sophisticated systems are able to determine which communication protocol the vehicle's on-board diagnostic system utilizes. On the other hand, less expensive units, for do-it yourselfers or small shop use, may only support either OBD-I or OBD-II and may also only support one specific communications protocol. Additionally, there are other more sophisticated universal diagnostic handheld devices capable of supporting both OBD-I and OBD-II, while also having the ability to determine which communication protocol the vehicle utilizes.

In the instance in which a small handheld diagnostic device is configured to support both OBD-I and OBD-II and also is capable of supporting numerous communication protocols, the diagnostic device must have the ability to determine which communication protocol is being utilized in the vehicle under test. However, as mentioned above such desirable features are costly and tend to drive up the cost of the diagnostic tool. Moreover, the response time (i.e. latency) to find the appropriate protocol may be longer than an average desired response time (i.e., undesired latency).

It would be beneficial to provide a protocol identifier which can be used for a universal handheld automotive diagnostic device that supports both OBD-I, OBD-II and is capable of determining which communication protocol the vehicle's on-board system implements. It would be further beneficial to provide a protocol identifier feature for handheld diagnostic tools which has a quick response time with respect to determining which protocol the vehicle under test utilizes. Preferably, the system would be simple and would help reduce the overall expense of the diagnostic device, instead of making the tool more expensive and complicated.

### BRIEF SUMMARY OF THE INVENTION

The aforementioned disadvantages are overcome by providing a method for identifying a specific communications protocol used in a vehicle's on-board diagnostic system, wherein the method is implemented using a handheld automotive diagnostic device and cable having a first and second connector, wherein the cable has unique physical layer features that may be correlated to a specific communications protocol.

The method comprises connecting the first connector to an input/output connector on the diagnostic device; powering up and initializing the diagnostic device; retrieving cable identification data unique to the physical layer features of the cable; and comparing the retrieved cable identification data with at least one look-up table to identify a correlated communications protocol.

According to an aspect of the present invention, the retrieved cable identification data is indicative of the type of connector used as the second connector. According to another aspect of the present invention, the retrieved cable identification data is indicative of the second connector's connectivity configuration. According to still yet another aspect of the present invention, the retrieved cable identification data is indicative of the second connector's pin configuration.

In another aspect of the present invention, the retrieved cable identification data correlates to the second connector's unique physical layer features. Additionally, in another aspect of the present invention, the retrieved cable identification data is indicative of the first connector's connectivity configuration. According to other aspects of the present invention, the retrieved cable identification data is indicative of the first connector's pin configuration. Furthermore, another aspect of the present invention includes the first connector having a specific pair of jumped pins that may be correlated to a specific communications protocol.

According to another aspect of the present invention, the method further comprises performing a continuity test to identify whether continuity exists between the specific pair of jumped pins. In another aspect of the present invention, the method further comprises determining from the retrieved cable identification data whether the second connector is a standardized OBD-II connector. In another aspect of the present invention, the second connector may be disconnected from the vehicle when the method is performed. According to other aspects of the present invention, the method further comprises connecting the second connector to the vehicle connector.

According to another aspect of the present invention, if a standardized OBD-II connector is detected, the communications protocol may be determined through a polling technique. In yet another aspect of the present invention, the polling technique comprises initializing a plurality of OBD-II compatible communication protocols in a serial manner until successful communication is established with the vehicle's on-board diagnostic system. In another aspect of the present invention, the plurality of communication protocols includes at least one of ISO9141, J1850 VPW, J1850 PWM, Keyword 2000, and CAN.

In another aspect of the present invention, a universal handheld automotive diagnostic device is provided which is compatible with OBD-I and OBD-II on-board diagnostics systems. The device is also compatible with a plurality of communications protocols supported by OBD-I and OBD-II. The device may comprise a central processing unit, memory, a display, a keypad, an input/output connector. The device further includes computer readable mediums comprising, a source code segment providing OBD-I functionality; a source code segment providing OBD-II functionality; source code segments providing functionality for a plurality of OBD-I communications protocols; and source codes segments providing functionality for a plurality of OBD-II communications protocols.

According to an aspect the present invention, the plurality of OBD-I communications protocols comprising at least one of GM, Ford, and Chrysler OBD-I communications protocol. According to another aspect of the present invention, the plurality of OBD-II communications protocols comprise at least one of ISO9141, J1850 VPW, J1850 PWM, Keyword 2000, and CAN.

According to other aspects of the present invention, the device may further include a cable identification sequencer, an OBD-I cable identification look-up table, an OBD-II unique cable identification look-up table, an OBD-II polling sequencer, and a continuity test sequencer.

Other exemplary embodiments and advantages of the present invention may be ascertained by reviewing the present disclosure and the accompanying drawings.

### BRIEF DESCRIPTION OF THE DRAWINGS

The present invention is further described in the detailed description that follows, by reference to the noted drawings by way of non-limiting examples of preferred embodiments of the present invention, in which like reference numerals represent similar parts throughout several views of the drawings, and in which:

FIG. 1 depicts a handheld automotive diagnostic tool and a data link connector cable, according to an aspect of the present invention;

FIG. 2 illustrates the system architecture of the handheld automotive diagnostic tool, according to an aspect of the present invention;

FIGS. 3A-B depict a first exemplary method for determining communication protocol from cables having OBD-I vehicle connectors, according to an aspect of the present invention;

FIG. 4 depicts the standardized OBD-II cable configuration between a diagnostic tool and the on-board diagnostics system of a vehicle;

FIG. 5 depicts an exemplary modified connector cable having a pin jumper installed between a pair of pins, according to an aspect of the present invention; and

FIGS. 6A-B depict a second exemplary method for determining communication protocol from a cable having an OBD-II vehicle connector, according to an aspect of the present invention; and

FIGS. 7A-B depict a third exemplary method for determining communication protocol from a cable having an OBD-II vehicle connector, according to an aspect of the present invention.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

### OVERVIEW OF THE PRESENT INVENTION

The present invention provides numerous embodiments of a system and method for determining the communication protocol of an on-board diagnostic system. In particular, the present invention provides a system and method for identifying a specific communication protocol used in a vehicle's on-board diagnostic system by retrieving unique data indicative of a unique cable.

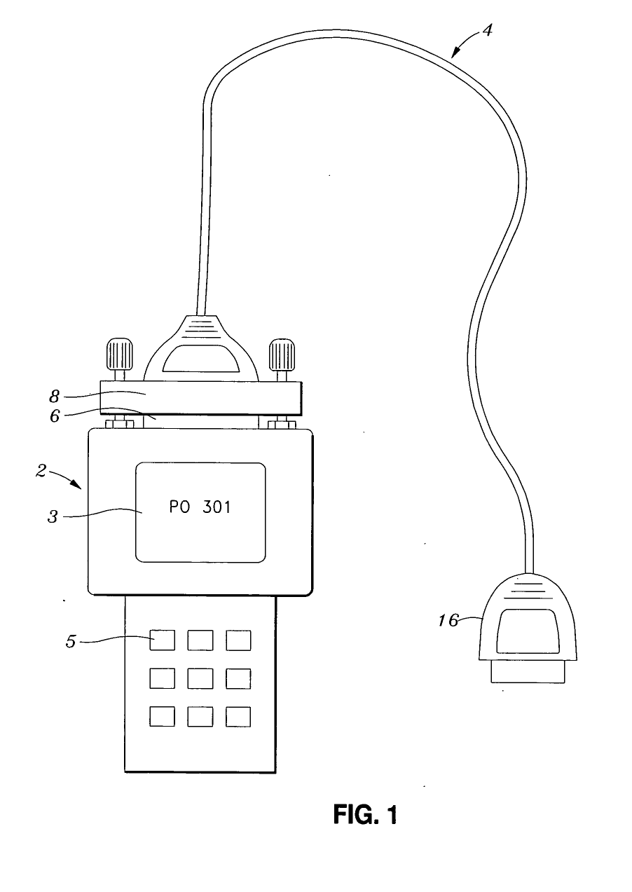

FIG. 1 depicts an exemplary handheld automotive diagnostic device 2 and connector cable 4, according to an aspect of the present invention. Preferably, the diagnostic device 2 is a universal diagnostic device which is compatible with both OBD-I and OBD-II standards. Moreover, it is preferable that the device 2 be adapted to support various communication protocols. Additionally, the diagnostic device 2 includes a connector 6 of which cable 4 is adapted to be connected thereto. The cable 4 has a first connector 8 which is adapted to be connected to the diagnostic device connector 6. On the opposing end of the cable 4, a second connector 10 is provided which is adapted to be connected to the vehicle's on-board diagnostics system connector 27.

Since the diagnostic device 2 is preferably universal, the connector cable 4 preferably is able to be connected to either (1) the various different vehicle connectors affiliated with OBD-I systems, or (2) connect to the standardized J1962 connector for OBD-II systems.

In the first instance, a cable 4 is provided having a unique second connector 10 for the specific manufacturer. For example, if the vehicle is a 1984 Chevrolet, the second connector 10 of the connector cable 4 is adapted to be connected to a 12-pin ALDL computer. If the vehicle is a 1988 Ford, an entirely different cable 4 is used which has a different second connector 10 adapted to be connected to an EEC-IV computer. Similarly, an entirely different cable 4 which has a different second connector 10 unique to the SCI computer is necessary for Chryslers. Thus, a unique cable 4 is required for each manufacturer with respect to OBD-I systems.

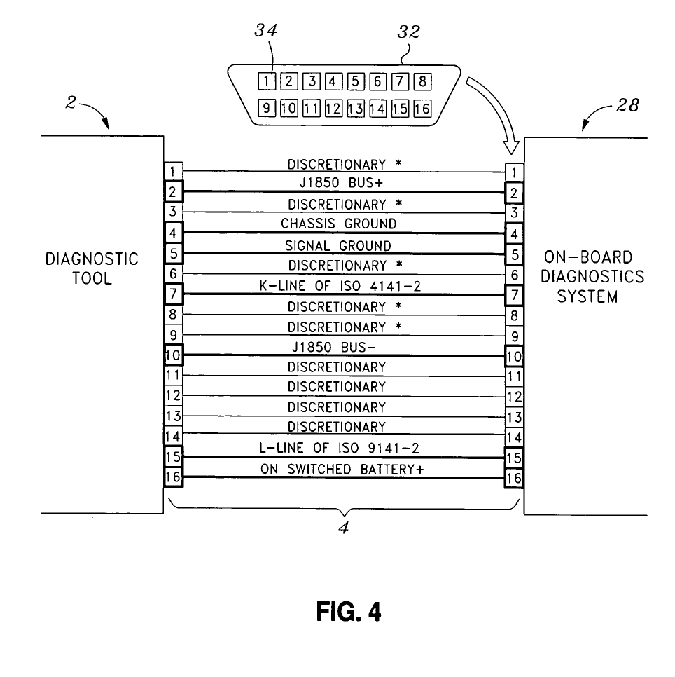

In the second instance, a universal connector cable 4 may be utilized instead of a different connector cable 4 for each specific manufacturer. For instance, if the vehicle utilizes the OBD-II standard, then per the standard, it is mandatory for the vehicle to utilize a J1962 connector (see FIG. 4, reference numeral 32).

### EXEMPLARY ARCHITECTURE OF THE PRESENT INVENTION

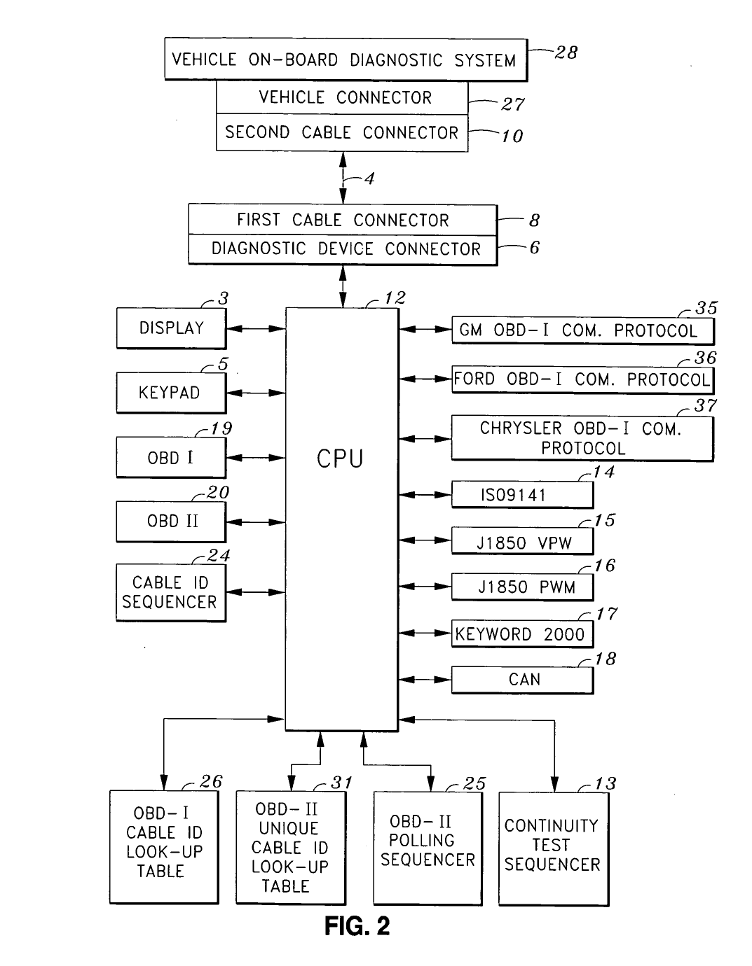

FIG. 2 illustrates an exemplary system architecture of the handheld automotive diagnostic device 2 which is compatible with both OBD I and OBD II, and furthermore, adapted to communicate with the vehicle on-board diagnostic system 28 via numerous communication protocols 14-18, 35-37, according to an aspect of the present invention.

In general, the diagnostic device 2 includes a central processing unit (CPU) or microprocessor 12 which performs various processing functions. The diagnostic device 2 also includes conventional features such as a display 3, keypad 5, and a diagnostic device connector 6.

The diagnostic device 2 includes on-board diagnostic functionality for both OBD-I and OBD-II protocols. The device 2 is preferably provided with various communication protocol functionality for OBD-II systems, including ISO9141, J1850 VPW, J1850 PWM, Keyword 2000 and CAN. For OBD-I systems, the diagnostics device preferably is provided with various communication protocol functionality for OBD-II systems, including protocols which support GM, Ford and Chrysler OBD-I communication protocols. It is further appreciated that the protocol functionality may be implemented in various manners known in the art, such as by software or dedicated hardware implementations. It is appreciated that any other OBD-I/II communication protocols that exist or developed in the future, could also be included in the diagnostic device 2.

Additionally, the device 2 includes other components including source code segments or circuitry for a cable identification sequencer 24, a continuity test sequencer 13, an OBD-I cable identification look-up table 26, and a unique cable identification look-up table 31, and a polling sequencer 25.

Method for Determining Communications Protocol via Cables with OBD-I Connectors

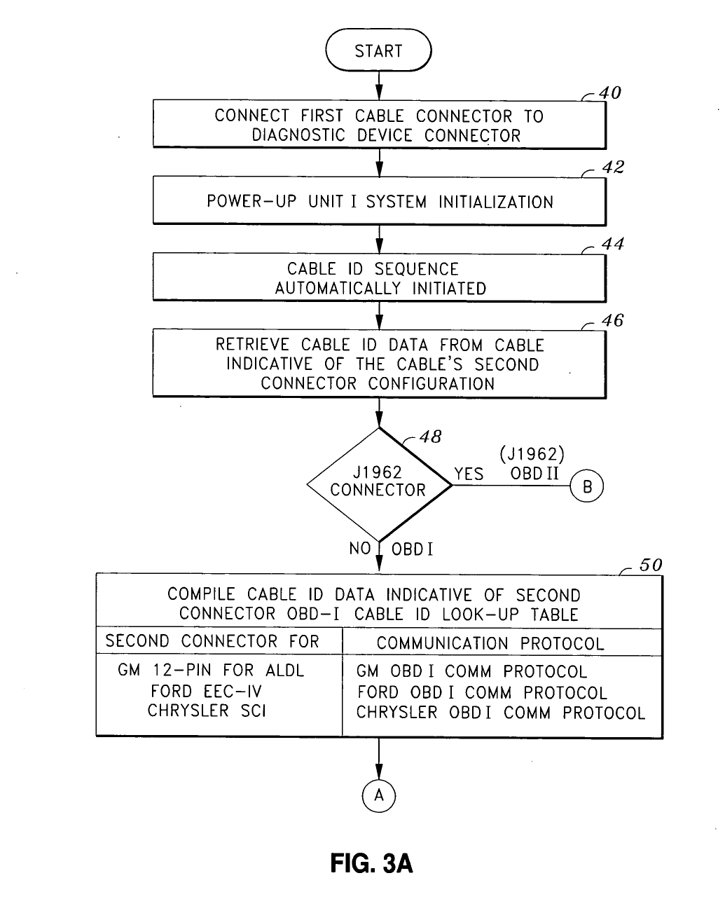

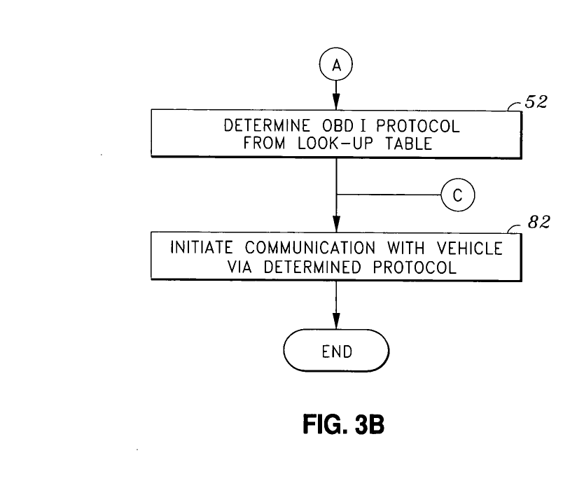

FIGS. 3A-B depict a first exemplary method for determining communication protocol from cables having OBD-I vehicle connectors, according to an aspect of the present invention. At step 40, at least the first cable connector 8 is connected to the diagnostic device connector 6. In the alternative, it is noted that the second cable connector end 10 may also be connected to the vehicle connector 27 without impacting the first exemplary method for determining communication protocol for vehicles with OBD-I systems. At step 42, the diagnostic device 2, is powered-up and initialized. At step 44, a cable identification sequence 24 is automatically initiated. At 46, cable identification data is retrieved from the cable 4 which is indicative of the cable's second connector 10 configuration or type of connector utilized as the second connector 10.

At step 48, if the second connector 10 is not a standardized J1962 connector, the cable identification data indicative of the second connector 10 is compared to an OBD-I cable identification look-up table 26 at step 50. The look-up table 26 (see FIGS. 2, 3) contains information on each type of second connector 10 utilized with the OBD-I protocol for each specific manufacturer. For instance, if the second connector 10 is a the type used for the GM 12-pin connector for ALDL computers, the OBD-I communications protocol 35 used in conjunction with the GM 12-pin connector for ALDL computers is determined at step 52. If the second connector 10 is a the type used for FORD EEC-IV computers, the OBD-I communications protocol 36 used in conjunction with the FORD EEC-IV computers is determined at step 52. Or, if the second connector 10 is a the type used for Chrysler SC1 computers, the OBD-I communications protocol 37 used in conjunction with the Chrysler SC1 computers is determined at determined at step 52. Finally at step 82, the diagnostic device 2 initiates communication with the vehicle on-board diagnostic system 28 via the determined OBD-I communications protocol.

System and Method for Determining OBD-II Communications Protocol with Unique Cables

FIG. 4 depicts the standardized OBD-II cable configuration between a diagnostic device 2 and the on-board diagnostics system 28 of a vehicle typically manufactured after 1995. Since the on-board diagnostics system 28 utilizes the OBD-II protocol, a standardized J1962 connector 32 is provided as an input/output port of the diagnostics system 28. FIG. 4 also shows the end view of the J1962 connector 32 which has sixteen pins 34. Of the sixteen pins 34, only seven of the pins 34 are standardized.

The function of each pin 34 is detailed in FIG. 4. For instance, pin #2 is dedicated to the J1850 bus +, pin #4 is dedicated to the chassis ground, pin #5 is dedicated to the signal ground, pin #7 is dedicated to the K-line of ISO 9142-2, pin #10 is dedicated to J1850 bus —, pin #15 is dedicated to the L-line of ISO 9141-2, and pin #16 is dedicated to the unswitched battery +. The remaining pins #'s 1, 3, 6, 8-9 and 11-14 are considered discretionary, and therefore, are available for use by the manufacturer and vary from vehicle to vehicle.

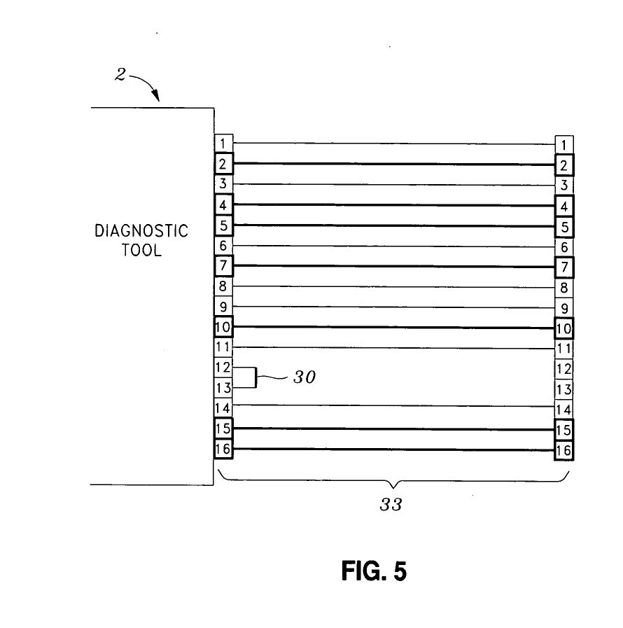

FIG. 5 depicts a modified connector cable 33 having a pin jumper 30 installed between pins 12 and 13, according to an aspect of the present invention. In this embodiment, a pin jumper 30 may be utilized to interconnect any of the discretionary pins #'s 1, 3, 6, 8-9 and 11-14. Thus, for example a jumper 30 may be installed between, pin #11 and pin #12, or perhaps between pin #13 and pin #14. It is therefore appreciated, that numerous permutations and combinations of pairs of discretionary pin pair may be jumped.

The purpose of the jumper 30 is to provide a continuous wire path on which a simple continuity test may be performed by the diagnostic device 2. When the first cable connector 8 is connected to the diagnostic tool connector 6, the diagnostic device 2 may be programmed or provided with an OBD-II continuity test sequencer 13 and circuitry to perform continuity tests through the various pins 34. The continuity test sequence 13 may be performed in a variety of manners known electronic arts and in integrated circuits. For example, the diagnostic device 2 may be provided with a digital voltmeter or ammeter circuit.

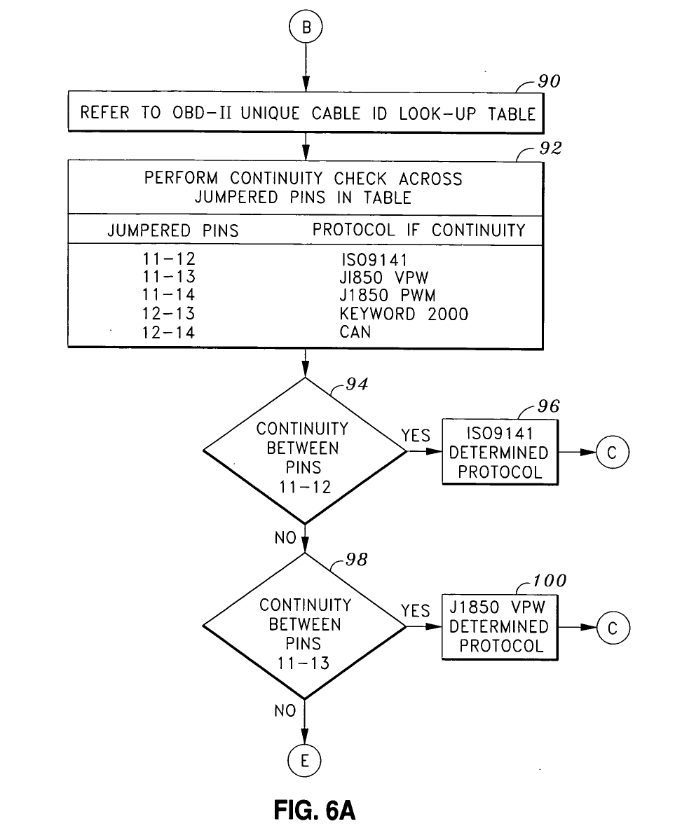

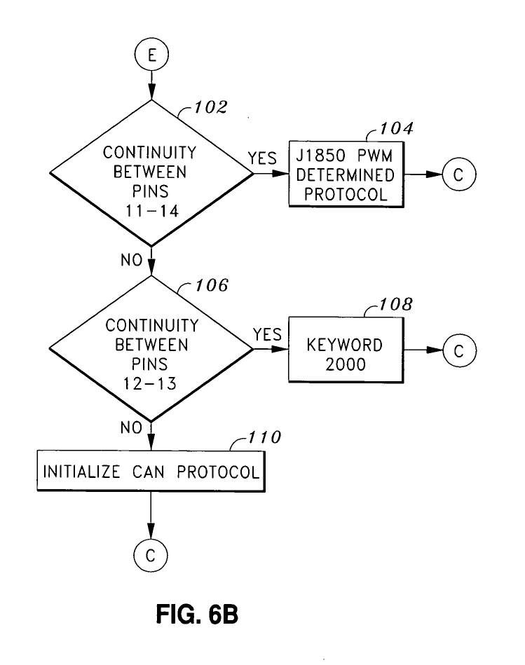

Furthermore, the diagnostic tool 2 is provided an OBD-II unique cable identification look-up table 31 (see FIGS. 2, 6A at step 92) which correlates various exemplary jumped pins 34 to specific data about the cable 33, in particular, a communication protocol. Thus, the diagnostic device 2 is capable of performing a test on any cable 4 or 33 which may or may not have a jumper 30 installed between two discretionary pins 34 the significance of which is indicative of a communications protocol. The manner in which the aforementioned continuity tests are performed will be further described later in the specification.

To perform the specific continuity tests on the protocol specific cable 33, the continuity test sequencer 13 performs the continuity checks on various potential jumped pin combinations listed in the OBD-II unique cable identification look-up table 31. In particular, the continuity test sequencer 13 performs a continuity check on each possible jumped pin pairing until a successful continuity test is performed. When continuity is identified with respect to a jumped pin pairing, the affiliated protocol is then able to be determined. Once the protocol that has been assigned to the respective jumped pair has been identified, the diagnostic device 2 initiates communication with the vehicle on-board diagnostic system 28 via the determined OBD-II communications protocol.

FIGS. 6A-B depict a second exemplary method for determining communication protocol from a cable having an OBD-II vehicle connector, according to an aspect of the present invention. Similar to that of the first exemplary method (see FIGS. 3A-B), it is noted that an advantage of the second exemplary method is that the cable 33 having the hardwired jumper 30, only has to be connected to the diagnostic device connector 6, and it does not have to be connected to the vehicle on-board diagnostics system.

First, at step 90, the diagnostic device 2 refers to the OBD-II unique cable ID look-up table 31. At step 92, a continuity check is performed across the jumped pins listed in the table 31. For example, for each communication protocol, a unique pair of discretionary pins may be jumped together. It is further noted that cable identification data may be presented in a variety of forms and should not be only limited to data representative of a pair of connectors 34 being jumped. At step 94, if continuity is measured between pins 11-12, at step 96 it is determined that ISO9141 is the determined protocol. At step 98, if continuity is measured between pins 11-13, at step 100 it is determined that J1850 VPW is the determined protocol. At step 102, if continuity is measured between pins 11-14, at step 104 it is determined that J1850 PWM is the determined protocol. At step 106, if continuity is measured between pins 12-13, at step 108 it is determined that Keyword 2000 is the determined protocol. At 110, it is determined that CAN is the determined protocol. Once the proper OBD-II communications protocol is identified, at step 82 (see FIGS. 3A-B), the diagnostic device 2 initiates communication with the vehicle on-board diagnostic system 28 via the determined OBD-II communications protocol.

Polling Method for Determining OBD-II Communications Protocols

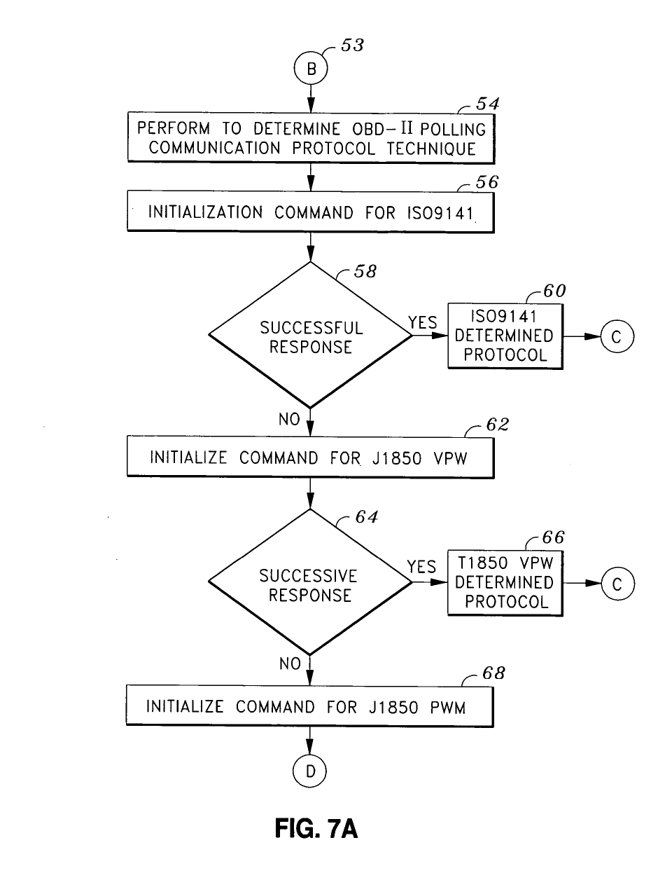

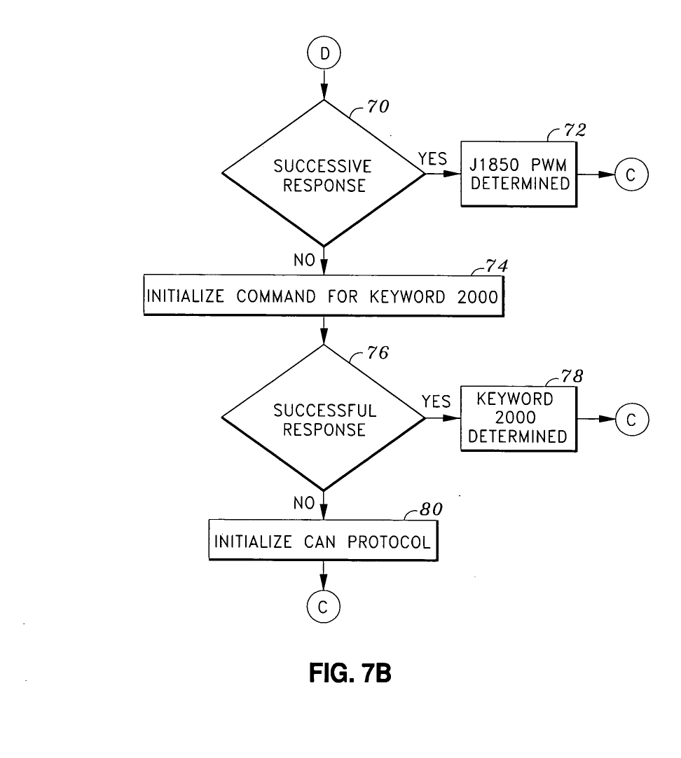

FIGS. 7A-B depict a polling method performed with/by the handheld automotive diagnostic tool 2 to determine the on-board diagnostic systems 28 communication protocol, according to an aspect of the present invention. This mode of the present invention may be performed if the cable connector 4 is connected to both the diagnostic device connector 6 and the vehicle's J1962 connector. Therefore at step 40 (see FIG. 3), the first cable connector 8 is connected the diagnostic device connector 6 and the second connector 10 is connected to the vehicle connector 27.

If at step 48 it is then determined that the second connector 10 is mated to a J1962 OBD-II connector, then the diagnostic device 2 may perform a polling technique to determine the OBD-II communications protocol at step 54, according to an alternative aspect of the present invention. In particular, at step 56 an initialization command for ISO9141 is sent to the vehicle on-board diagnostic system 28. If at step 58 a successful communications response is received from the on-board diagnostic system 28, then at step 60 ISO9141 is the determined protocol. If at step 58 there is not a successful response, at step 62 an initialization command for J1850 VPW is sent to the vehicle on-board diagnostic system 28. If at step 64 a successful communications response is received from the on-board diagnostic system 28, then at step 66 J1850 VPW is the determined protocol. If at step 64 there is not a successful response, at step 68 an initialization command for J1850 PWM is sent to the vehicle on-board diagnostic system 28. If at step 70 a successful communications response is received from the on-board diagnostic system 28, then at step 72 J1850 PWM is the determined protocol. If at step 70 there is not a successful response, at step 74 an initialization command for Keyword 2000 is sent to the vehicle on-board diagnostic system 28. If at step 76 a successful communications response is received from the on-board diagnostic system 28, then at step 79 Keyword 2000 is the determined protocol. If at 76 there is not a successful response, at step 80 an initialization command for the CAN protocol is sent. It is further appreciated that the polling technique may also include other protocols, such as the OBD-I communications protocols 35-37 (GM, Ford, Chrysler, etc.) or any other protocol compatible with OBD-I/II systems. Once the proper OBD-II communications protocol is identified, at step 82 the diagnostic device 2 initiates communication with the vehicle on-board diagnostic system 28 via the determined OBD-II communications protocol.

In accordance with various embodiments of the present invention, the methods described herein may be implemented as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual processing can also be constructed to implement the methods described herein.

It should also be noted that the software implementations of the present invention as described herein are optionally stored on a tangible storage medium, such as: a magnetic medium such as disk or tape; a magneto-optical or optical medium such as a disk; or a solid state medium such as a memory card or other package that houses one or more read-only (non-volatile) memories, random access memories, or other re-writable (volatile) memories. Accordingly, the invention is considered to include a tangible storage medium or distribution medium, as listed herein and includes art recognized equivalents and successor media, in which the software implementations herein are stored.

Although the present invention includes components and functions in the embodiments with reference to particular standards (e.g., OBI, OBII), the invention is not limited to such standards and protocols. Such standards are periodically superseded by faster or more efficient equivalents having essentially the same functions. Accordingly, replacement standards and protocols having the same functions are considered equivalents.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such are within the scope of the appended claims.

1. A method for identifying a specific communications protocol used in a vehicle's on-board diagnostic system, wherein the method is implemented using a handheld automotive diagnostic device and cable having a first and second connector, wherein the cable has unique physical layer features that may be correlated to a specific communications protocol, the method comprising:
connecting the first connector to an input/output connector on the diagnostic device;
powering up and initializing the diagnostic device;
retrieving cable identification data unique to the physical layer features of the cable; and
comparing the retrieved cable identification data with at least one look-up table to identify a correlated communications protocol.

2. The method according to claim 1, wherein the retrieved cable identification data is indicative of the type of connector used as the second connector.

3. The method according to claim 1, wherein the retrieved cable identification data is indicative of the second connector's connectivity configuration.

4. The method according to claim 1, wherein the retrieved cable identification data is indicative of the second connector's pin configuration.

5. The method according to claim 1, wherein the retrieved cable identification data correlates to the second connector's unique physical layer features.

6. The method according to claim 1, wherein the retrieved cable identification data is indicative of the first connector's connectivity configuration.

7. The method according to claim 1, wherein the retrieved cable identification data is indicative of the first connector's pin configuration.

8. The method according to claim 7, wherein the first connector includes a specific pair of jumped pins that may be correlated to a specific communications protocol.

9. The method according to claim 8, further comprising performing a continuity test to identify whether continuity exists between the specific pair of jumped pins.

10. The method according to claim 1, further comprising determining from the retrieved cable identification data whether the second connector is a standardized OBD-II connector.

11. The method according to claim 1, wherein the second connector may be disconnected from the vehicle when the method is performed.

12. The method according to claim 1, further comprising connecting the second connector to the vehicle connector.

13. The method according to claim 12, wherein if a standardized OBD-II connector is detected, the communications protocol may be determined through a polling technique.

14. The method according to claim 11, wherein the polling technique comprises initializing a plurality of OBD-II compatible communication protocols in a serial manner until successful communication is established with the vehicle's on-board diagnostic system.

15. The method according to claim 14, wherein the plurality of communication protocols includes at least one of ISO9141, J1850 VPW, J1850 PWM, Keyword 2000, and CAN

16. A universal handheld automotive diagnostic device compatible with OBD-I and OBD-II on-board diagnostics systems, said device also compatible with a plurality of communications protocols supported by OBD-I and OBD-II, said device comprising:
a central processing unit;
memory;
a display;
a keypad;
an input/output connector;
and computer readable mediums comprising,
a source code segment providing OBD-I functionality;
a source code segment providing OBD-II functionality;
source code segments providing functionality for a plurality of OBD-I communications protocols; and
source codes segments providing functionality for a plurality of OBD-II communications protocols.

17. The device according to claim 16, said plurality of OBD-I communications protocols comprising at least one of GM, Ford, and Chrysler OBD-I communications protocol.

18. The device according to claim 16, said plurality of OBD-II communications protocols comprising at least one of ISO9141, J1850 VPW, J1850 PWM, Keyword 2000, and CAN.

19. The device according to claim 16, further comprising a cable identification sequencer.

20. The device according to claim 16, further comprising an OBD-I cable identification look-up table.

21. The device according to claim 16, further comprising an OBD-II unique cable identification look-up table.

22. The device according to claim 16, further comprising an OBD-II polling sequencer.

23. The device according to claim 16, further comprising a continuity test sequencer.
